(19) United States
(12) Patent Application Publication
(10) Pub. No.: US 2017/0041698 A1
(43) Pub. Date: Feb. 9, 2017

(54) Wireless Headset System

(71) Applicant: Alexis Ransom, Natchez, MS (US)

(72) Inventor: Alexis Ransom, Natchez, MS (US)

(21) Appl. No.: 15/229,809

(22) Filed: Aug. 5, 2016

Related U.S. Application Data
(60) Provisional application No. 62/201,134, filed on Aug. 5, 2015.

(51) Int. Cl. H04R 1/10

(52) U.S. Cl. CPC H04R 1/1041; H04R 2420/07; H04R 2420/05

(57) ABSTRACT

A wireless headset system. The wireless headset system includes an input jack that can connect to a host electronic device, such as a cellular phone, via a connector. The host electronic device can transmit audio data to the input jack, which in turn wirelessly transmits the audio data to a headphone assembly. The headphone assembly includes a speaker that can transmit the audio data into audible sound. In one embodiment, the input jack and the headphone assembly share a unique identification code for allowing secure communication therebetween. The input jack further includes a switch that allows wireless communication of the audio data from either the input jack or the host electronic device to the headphone assembly.

### CROSS REFERENCE TO RELATED APPLICATION

This application claims the benefit of U.S. Provisional Application No. 62/201,134 filed on Aug. 5, 2015. The above identified patent application is herein incorporated by reference in its entirety to provide continuity of disclosure.

### BACKGROUND OF THE INVENTION

### Field of the Invention

The present invention relates to a wireless headset system. More specifically, the present invention provides a wireless headset system comprising an input jack that is configured to couple to an electronic device and wirelessly communicate data, such as audio data, to a headphone assembly.

Many individuals listen to music, presentations, and phone calls through headphones and earbuds that play sound through speakers. Headphones and earbuds provide the user privacy to listen to the audio without others interfering with their enjoyment, and does not create a disturbance for others by localizing the sound to the users. Conventional headphones and earbuds are usually wired to an electronic device that stores audio files and data. The headphones play the audio data through speakers that are configured to be worn over or adjacent to one's ears.

These devices, however, have several deficiencies. For example, wired headphones easily become tangled, requiring the user to frequently untangle the wire prior to use thereof. Further, the wired headphones limit the distance a user can travel from the electronic device.

As a solution, some attempts have been made to produce wireless headphones that do not require a wired connection between the headphone and electronic device. However, these wireless headphones require that the electronic device include wireless transceivers of their own to be compatible with the headphones. Further, these headphones can wirelessly connect with electronic devices of questionable security.

In light of the devices disclosed in the prior art, it is submitted that the present invention substantially diverges in design elements from the prior art and consequently it is clear that there is a need in the art for an improvement to existing headset devices. In this regard the instant invention substantially fulfills these needs.

### SUMMARY OF THE INVENTION

In view of the foregoing disadvantages inherent in the known types of wireless headsets now present in the prior art, the present invention provides a new wireless headset system wherein the same can be utilized for providing convenience for the user when listening to audio from an electronic device.

It is therefore an object of the present invention to provide a new and improved wireless headset system that has all of the advantages of the known art, and none of the disadvantages. The wireless headset system includes an input jack comprising a first wireless transceiver and a connector that is configured to electronically couple with a host electronic device. The host electronic device is configured to transmit audio data to the input jack, wherein the input jack is configured to wirelessly communicate the audio data to a headphone assembly including a speaker configured to produce audible sound.

It is another object of the present invention to provide secure wireless communication between the input jack and the headphone assembly via a unique identification code that pairs the input jack and the headphone assembly.

Another object of the present invention is to provide a wireless communication between the input jack and the headphone assembly via Bluetooth protocol.

Yet another object of the present invention is to provide the input jack that further comprises an actuatable switch configured for changing the first wireless transceiver between an activated state and a deactivated state.

Yet another object of the present invention is to provide the wireless headset system wherein upon detecting the first wireless transceiver in the deactivated state, the input jack is configured to transmit a unique identification code to the host electronic device, the unique identification code permitting secure communication between the host electronic device and the headphone assembly; wherein upon receiving the unique identification code, the second wireless transceiver of the host electronic device is configured to wirelessly pair to the headphone assembly and communicate the audio data to the headphone assembly; wherein upon receiving the audio data from the input jack, the speaker of the headphone assembly is configured to produce audible sound.

Another object of the present invention is to provide a wireless headset system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic diagram of the wireless headset system.

FIG. 2 shows a flowchart of one exemplary method of the wireless headset system.

### DETAILED DESCRIPTION OF THE INVENTION

Reference is made herein to the attached drawings. Like reference numerals are used throughout the drawings to depict like or similar elements of the wireless headset system. For the purposes of presenting a brief and clear description of the present invention, the preferred embodiment will be discussed as used for wirelessly transmitting audio data from a host electronic device to a headphone assembly that plays the audio data through a speaker. The figures are intended for representative purposes only and should not be considered to be limiting in any respect.

As used herein, “logic” refers to (i) logic implemented as computer instructions and/or within one or more computer processes and/or (ii) logic implemented in electronic circuitry. As used herein, “computer-readable medium” excludes any transitory signals, but includes any non-transitory data storage circuitry, e.g., buffer cache, and queues, within transceivers of transitory signals. In the interest of economy, the present disclosure refers to “computer-readable medium,” “a processor,” “a database,” and so on. However, this should not be read as limiting in any way as the present disclosure contemplates embodiments of the present invention utilizing “one or more computer-readable media,” “one or more processors,” “one or more databases,” and so on. Unless specifically limited to a single unit, “a” is intended to be equivalent to “one or more” throughout the present disclosure.

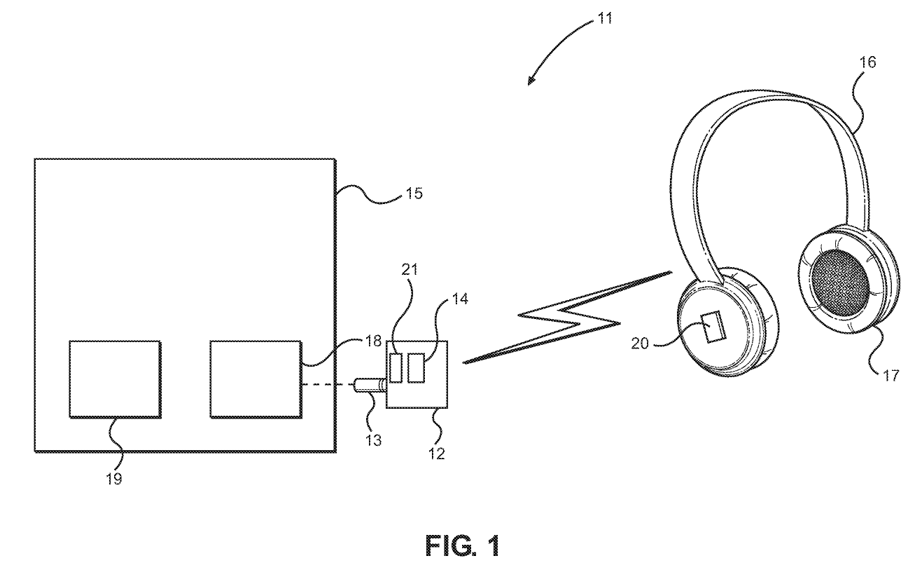

Referring now to FIG. 1, there is shown a schematic diagram of the wireless headset system. The wireless headset system 11 comprises an input jack 12 in wireless communication with a headphone assembly 16. The input jack 12 includes a connector 13 and a first wireless transceiver 14. The connector 13 is configured to electronically couple with a host electronic device 15, such as a smartphone, tablet, and the like. The connector 13 may include any electrical port, plug, and the like. In the shown embodiment, the connector 13 is a male phone connector configured to be received by a female phone connector 18 of the host electronic device 15. The host electronic device 15 is configured to transmit audio data to the input jack 12 via the connector 13. The audio data may be stored on local memory storage disposed within the host electronic device 15, or memory storage from a remote server, such as the internet operably connected thereto.

The headphone assembly 16 is configured to be worn over or adjacent to one's ears and includes a speaker 17 configured to produce audible sound. In one embodiment, the headphone assembly 16 includes a pair of speakers 17 that are positionable over both ears of the user. Further, the headphone assembly 16 includes a wireless receiver 20 configured to receive data, such as audio data and files, and transmit the audio data into audible sound via the speaker 17. In one use, the input jack 12 transmits the audio data via the first wireless transceiver 14 to the wireless receiver 20 of the headphone assembly 16 upon receiving audio data from the host electronic device 15. Upon receiving the audio data from the input jack 12, the speaker 17 of the headphone assembly 16 produces audible sound.

In one embodiment, the input jack 12 further comprises an actuatable switch 21 for changing the first wireless transceiver 14 between an activated state and a deactivated state. In the activated state, the first wireless transceiver 14 provides for wireless communication between the first wireless transceiver 14 and the headphone assembly 17. In the deactivated state, the first wireless transceiver 14 shuts down wireless communication with the headphone assembly 17. In one embodiment, the actuatable switch 21 is button, whereby a first depression causes the first wireless transceiver 14 to change from the activated state to the deactivated state. A second depression causes the first wireless transceiver 14 to change from the deactivated state to the activated state.

In one embodiment, the input jack 12 and the headphone assembly 16 share a unique identification code configured to provide secure communication therebetween. The unique identification code may include an alphanumerical password or authentication sequence that establishes a secure wireless communication link.

In another embodiment, the wireless headset system 11 provides wireless communication between the host electronic device 15 and the headphone assembly 16. The input jack 12 is configured to detect the host electronic device 15 comprising a second wireless transceiver 19. Upon detecting the first wireless transceiver 19 in the deactivated state, the input jack 12 is configured to transmit the unique identification code to the host electronic device 15 permitting secure communication between the host electronic device 15 and the headphone assembly 16. Upon receiving the unique identification code, the second wireless transceiver 19 of the host electronic device 15 is configured to wirelessly pair to the headphone assembly 16 and communicate the audio data thereto. Upon receiving the audio data from the host electronic device 15, the speaker 17 of the headphone assembly 16 is configured to produce audible sound.

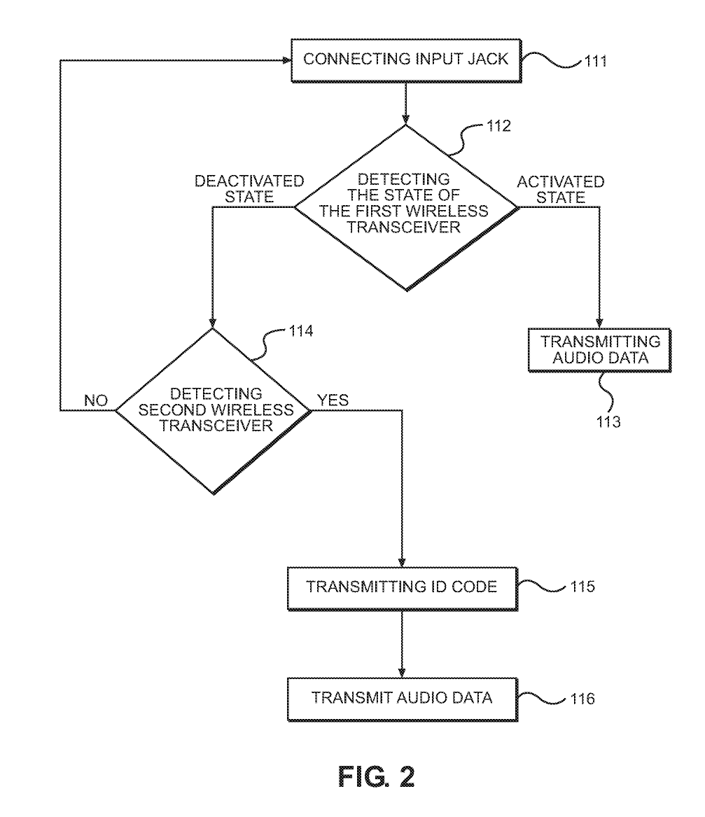

Referring now to FIG. 2, there is shown a flowchart of one exemplary method of the wireless headset system. The present invention utilizes logic stored on a computer-readably medium that, when executed by a processor of the present invention, causes the wireless headset system to perform a number of steps including detecting a connection 111 between an input jack that is paired to a headphone assembly to a host electronic device via a connector, detecting the state of a first wireless transceiver 112, transmitting audio data to the headphone assembly utilizing the first wireless transceiver 113, detecting if the host electronic device comprises a second wireless transceiver 114, transmitting a unique identification code to the host electronic device 115, and transmitting audio data to a headphone assembly utilizing the second wireless transceiver 116.

In the shown method of the present invention, the wireless headset system detects and utilizes a connection between an input jack and a host electronic device 111 to wirelessly transmit audio data from the host electronic device to the headphone assembly via the first wireless transceiver. The input jack further comprises an actuatable switch configured to change the first wireless transceiver between an activated state and a deactivated state. The activation state of the first wireless transceiver is periodically detected 112. In the activated state, the first wireless transceiver provides for wireless communication between the first wireless transceiver and the headphone assembly. In the deactivated state, the first wireless transceiver shuts down wireless communication with the headphone assembly.

Upon detecting the first wireless transceiver in the activated state, the input jack transmits audio data to the headphone assembly utilizing the first wireless transceiver 113. Upon detecting the first wireless transceiver in the deactivated state, the present system attempts to detect if the host electronic device comprises a second wireless transceiver 114. Upon detecting the second wireless transceiver, a unique identification code is transmitted 115 to the host electronic device. The unique identification code allows secure wireless communication between the host electronic device and the headphone assembly. Once secure wireless communication has been established, the host electronic device transmits audio data to the headphone assembly utilizing the second wireless transceiver 116.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wireless headset system comprising:
an input jack including a connector and a first wireless transceiver;
the connector configured to electronically couple with a host electronic device, the host electronic device configured to transmit audio data to the input jack;
a headphone assembly including a speaker and wireless receiver, the speaker configured to produce audible sound;
wherein upon receiving audio data from the host electronic device, the input jack is configured to wirelessly communicate the audio data to the headphone assembly via the first wireless transceiver.

2) The wireless headset system of claim 1, wherein upon receiving the audio data from the input jack, the speaker of the headphone assembly is configured to produce audible sound.

3) The wireless headset system of claim 1, wherein the input jack and the headphone assembly share a unique identification code for allowing secure communication therebetween.

4) The wireless headset system of claim 1, wherein the connector of the input jack is a phone connector.

5) The wireless headset system of claim 1, wherein the first wireless transceiver wirelessly communicates to the headphone assembly via Bluetooth protocol.

6) The wireless headset system of claim 1, wherein the input jack further comprises an actuatable switch configured for changing the first wireless transceiver between an activated state and a deactivated state.

7) The wireless headset system of claim 6, wherein:
the input jack is configured to detect a second wireless transceiver of the host electronic device;
wherein upon detecting the first wireless transceiver in the deactivated state, the input jack is configured to transmit a unique identification code to the host electronic device, the unique identification code permitting secure communication between the host electronic device and the headphone assembly;
wherein upon receiving the unique identification code, the second wireless transceiver of the host electronic device is configured to wirelessly pair to the headphone assembly and communicate the audio data to the headphone assembly;
wherein upon receiving the audio data from the host electronic device, the speaker of the headphone assembly is configured to produce audible sound.

8) A method of wirelessly communicating audio data to a headphone assembly comprising the steps of:
detecting a connection between an input jack that is paired to a headphone assembly to a host electronic device via a connector, the input jack comprising a first wireless transceiver and an actuatable switch configured to change the first wireless transceiver between an activated state and a deactivated state;
detecting whether the first wireless transceiver is in the activated state or the deactivated state;
upon detecting the first wireless transceiver in the activated state, transmitting audio data to the headphone assembly utilizing the first wireless transceiver.

9) The method of claim 8, further comprising the steps of:
upon detecting the first wireless transceiver in the deactivated state, detecting if the host electronic device comprises a second wireless transceiver;
upon detecting the second wireless transceiver, transmitting a unique identification code to the host electronic device, wherein the unique identification code allows secure wireless communication between the host electronic device and the headphone assembly;
transmitting audio data to a headphone assembly utilizing the second wireless transceiver.
